(19) United States
(12) Patent Application Publication
(10) Pub. No.: US 2019/0308488 A1
(43) Pub. Date: Oct. 10, 2019

(54) CLIMATE CONTROL SYSTEM WITH OUTLET SHUTOFF MECHANISM OF COMPACT DESIGN

(71) Applicant: FORD GLOBAL TECHNOLOGIES, LLC, Dearborn, MI (US)

(72) Inventors: Jose A. Nava, Plymouth, MI (US); Mukesh Kumar, Canton, MI (US); Gary D. Marshall, Sterling Heights, MI (US); Jennifer A. Herr-Rathke, Plymouth, MI (US)

(21) Appl. No.: 15/949,680

(22) Filed: Apr. 10, 2018

(51) Int. Cl. B60H 1/00; B60H 1/24

(52) U.S. Cl. CPC B60H 1/00842; B60H 1/00564; B60H 2001/3471; B60H 1/242; B60H 2001/00185; B60H 1/00692

(57) ABSTRACT

A climate control system includes an outlet shutoff mechanism and an HVAC plenum delivering conditioned air to the outlet shutoff mechanism. The outlet shutoff mechanism includes a housing, having a guideway and a first air discharge outlet, a flexible door, displaceable along the guideway between a first position and a second position, and an actuator feature to displace the flexible door.

### TECHNICAL FIELD

This document relates generally to the motor vehicle equipment field and, more particularly, to a new and improved apparatus, in the form of an outlet shutoff mechanism, having a compact design adapted for use in a constrained space, as well as to a climate control system incorporating that outlet shutoff mechanism.

### BACKGROUND

Electrical energy and fuel energy savings are very important considerations in the development of a climate control system for a motor vehicle. Toward this end, new methods of controlling the air flow of a climate control system have been developed including one sometimes referred to as “driver only mode.” This mode of air flow is defined as controllability at the hands of the driver to shut off air flow through the passenger side outboard vent register and potentially through the passenger side inboard registers at the push of a button. This document relates to a new and improved outlet shutoff mechanism and climate control system that may be utilized to enable driver only mode even in the most package constrained instrument panel environment.

### SUMMARY

In accordance with the purposes and benefits described herein, a new and improved apparatus is provided. That apparatus comprises an outlet shutoff mechanism including a housing having a guideway and a first air discharge outlet. The outlet shutoff mechanism further includes a flexible door having an elongated body with a barrier section at a first end and a drive section at a second end. The flexible door is displaceable along the guideway between a first position wherein the first air discharge outlet is open and a second position wherein the first air discharge outlet is closed. Further, the outlet shutoff mechanism includes an actuator feature to displace the flexible door between the first position and the second position.

The actuator feature may include a drive motor connected to a drive shaft. A first pinion may be carried on that drive shaft. Further, the actuator feature may include a first rack. That first rack may be carried on the drive section of the flexible door. The first rack may be engaged by that first pinion. The first rack may comprise a first line of apertures provided in the drive section of the flexible door.

The guideway may include a curve along an intermediate section of the guideway. That curve may have an arc defining an acute included angle. The guideway may include a first guide track and a second guide track opposed to the first guide track. More specifically, the housing may include a first sidewall and a second sidewall. The first guide track may be carried on the first sidewall. The second guide track may be carried on the second sidewall. The flexible door may have a first margin received in and sliding along the first guide track and a second margin received in and sliding along the second guide track. In one or more of the possible embodiments of the apparatus, the actuator feature may include a second pinion carried on the drive shaft and a second rack on the drive section engaged by the second pinion. That second rack may comprise a second line of apertures provided in the drive section in a direction parallel to the first line of apertures.

In one or more of the many possible embodiments of the apparatus, the housing may include a bottom wall extending between the first sidewall and the second wall. Further, the housing may include a second air discharge outlet. In one or more of the many possible embodiment, the first air discharge outlet may lead to a downstream outboard front passenger side air register. The second air discharge outlet may direct an airstream to a downstream inboard front passenger side air register.

In one or more of the many possible embodiments of the apparatus, the barrier section of the flexible door may be continuous and rackless.

In accordance with an additional aspect, a climate control system is provided. That climate control system comprises an outlet shutoff mechanism and an HVAC plenum delivering conditioned air to the outlet shutoff mechanism. Further, the climate control system is characterized by the outlet shutoff mechanism including a) a first air discharge outlet connected to a downstream outboard front passenger side air register and b) a flexible door displaceable along a guideway between a first position wherein the first discharge outlet is open and a second position wherein the first discharge outlet is closed. In the second position a greater volume of conditioned air is directed by the climate control system toward a driver of a motor vehicle.

The flexible door may have an elongated body including a barrier section at a first end and a drive section at a second end. In addition, the outlet shutoff system may further include an actuator feature to displace the flexible door between the first position and the second position. That actuator feature may include a drive motor connected to a drive shaft, at least one pinion carried on the drive shaft and at least one rack carried on the flexible door. That at least one rack may comprise at least one line of apertures in the flexible door that are engaged by teeth by the at least one pinion.

The guideway of the outlet shutoff mechanism may include a curve along an intermediate section of the guideway. That curve may have an arc that defines an acute included angle which functions to minimize the space requirements for the outlet shutoff mechanism thereby adapting that mechanism to a constrained package space such as found beneath the instrument panel in many of today's motor vehicles.

In accordance with yet another aspect, an apparatus is provided that comprises a housing, including a guideway and a first air discharge outlet, and a flexible door displaceable along that guideway between a first position opening a first air discharge outlet and a second position closing the first air discharge outlet. That guideway includes a curve having an arc defining an acute included angle so that the guideway and the flexible door fold back slightly on themselves in order to minimize the space occupied by the apparatus.

In the following description, there are shown and described several preferred embodiments of the apparatus and the climate control system. As it should be realized, the apparatus and the climate system are capable of other, different embodiments and their several details are capable of modification in various, obvious aspects all without departing from the apparatus and climate control system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and climate control system and together with the description serve to explain certain principles thereof. In the drawing figures:

FIG. 1 is a perspective view of the new and improved climate control system incorporating a compact outlet shutoff mechanism.

FIG. 2 is an end view of the climate control system illustrated in FIG. 1.

FIG. 3a is a detailed schematic view of part of the actuator feature of the outlet shutoff mechanism illustrating how the teeth of the first pinion engage in the first line of apertures that form the first rack in the flexible door of the outlet shutoff mechanism.

FIG. 3b is a detailed cross-section illustrating the guideway for the flexible door of the outlet shutoff mechanism.

FIG. 4 is an elevational view of the instrument panel of a motor vehicle equipped with the climate control system of FIGS. 1 and 2 illustrating the position of the air vent registers in the instrument panel of the motor vehicle.

FIG. 5 is a schematic illustration of the climate control system illustrating how the outlet shutoff mechanism of that system may be utilized to shut off airflow to an outboard passenger side vent register in order to provide the climate control system with a driver only mode of operation.

Reference will now be made in detail to the present preferred embodiments of the apparatus and climate system, examples of which are illustrated in the accompanying drawing figures.

### DETAILED DESCRIPTION

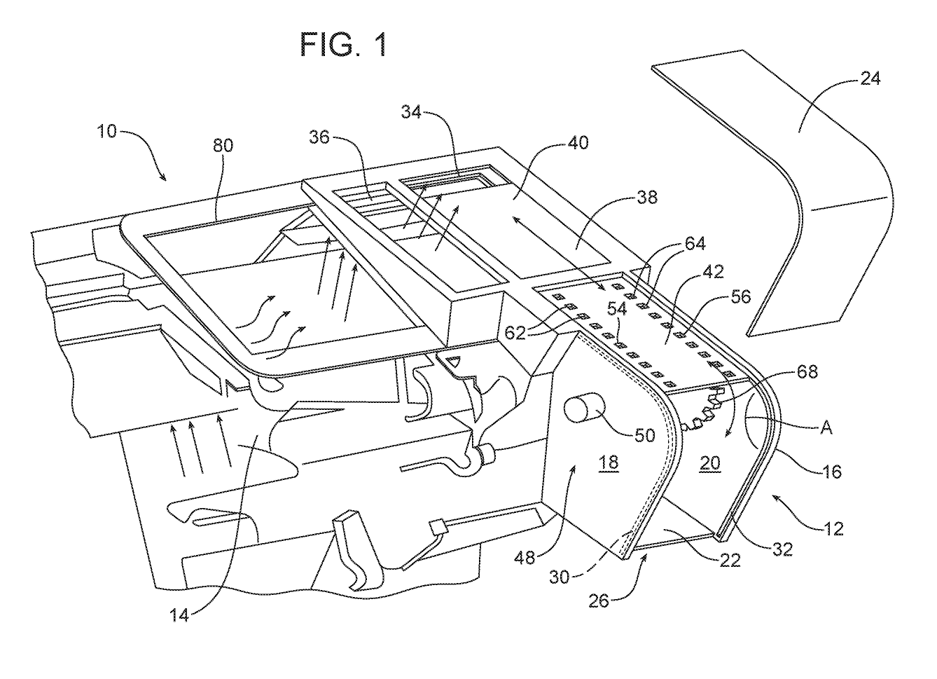

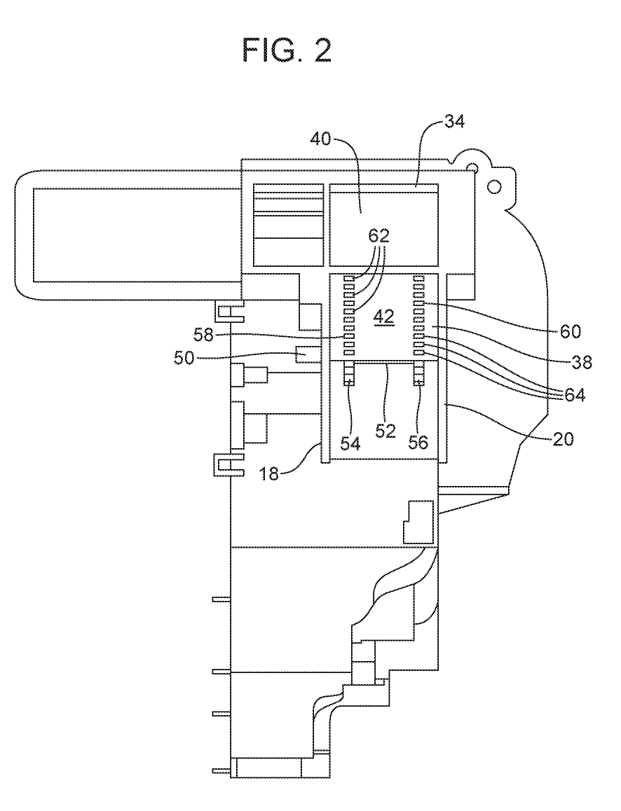

Reference is now made to FIGS. 1 and 2 which illustrate the new and improved climate control system 10 having an apparatus in the form of an outlet shutoff mechanism 12 and a heating, ventilating and air conditioning (HVAC) plenum 14 that delivers conditioned air to the outlet shutoff mechanism.

More specifically, the outlet shutoff mechanism 12 includes a housing 16 having a first sidewall 18, a second sidewall 20, a bottom wall 22 and a removable cover 24. The removable cover 24 is exploded away from the first sidewall 18, second sidewall 20 and bottom wall 22 in FIG. 1 and is not shown in FIG. 2 so as not to conceal the other components of the outlet shutoff mechanism 12 described in greater detail below. As should be appreciated from viewing FIGS. 1 and 2, the first sidewall 18, the second sidewall 20 and the bottom wall 22 of the housing 16 form a substantially U-shaped structure having an open end 26 when the cover 24 is removed. This allows for ease of assembly and maintenance.

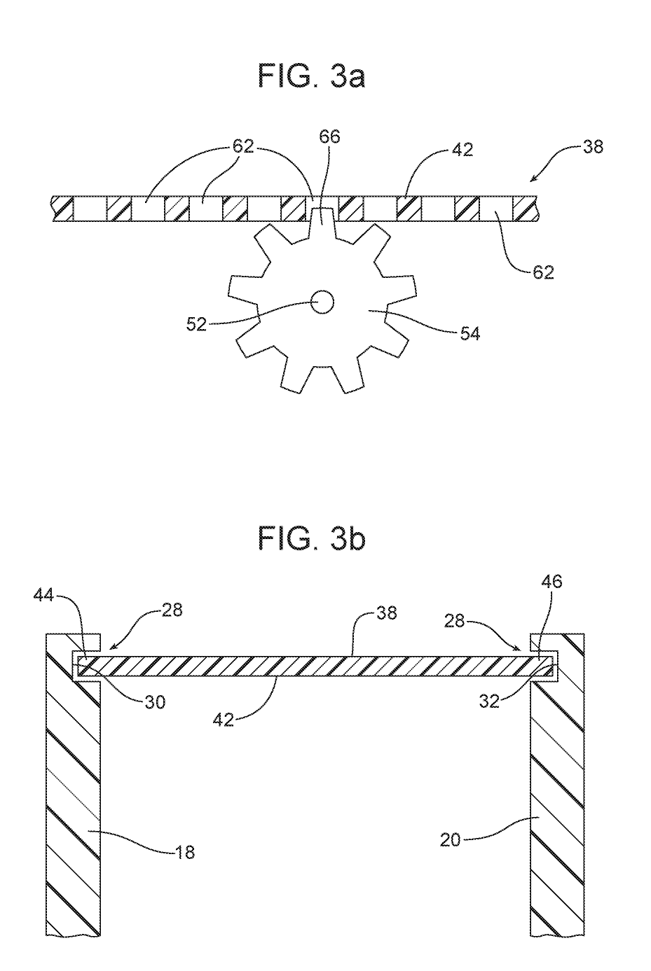

In the illustrated embodiment, the housing 16 includes a guideway, generally designated by reference numeral 28. That guideway 28 comprises a first guide track 30 carried on the first sidewall 18 and a second guide track 32 carried on the second sidewall 20 opposed to the first guide track. See FIGS. 1 and 3b. The guideway 28 and, therefore, the first guide track 30 and the second guide track 32 curve along an intermediate section and that curve defines an acute included angle A. The housing 16 also includes a first air discharge outlet 34 and a second air discharge outlet 36.

The outlet shutoff mechanism 12 also includes a flexible door 38 having an elongated body with a barrier section 40 at a first end a drive section 42 at a second end. The flexible door 38 is displaceable along the guideway 28 between a first position wherein the first air discharge outlet 34 is open and a second position wherein the first air discharge outlet is closed. More specifically, the flexible door includes a first edge margin 44 that is received in and slides along the first guide track 30 and a second edge margin 46 that is received in and slides along the second guide track 32.

An actuator feature 48 functions to displace the flexible door 38 between the first position and the second position in a manner described in greater detail below. The actuator feature 48 includes a drive motor 50 which is fixed to the first sidewall 18 in the illustrated embodiment. The drive motor 50 is connected to a drive shaft 52. A first pinion 54 and a second pinion 56 are keyed to the drive shaft 52. See FIGS. 1, 2 and 3a.

The actuator feature 48 also includes a first rack 58 and a second rack 60 carried on the drive section 42 of the flexible door 38. In the illustrated embodiment, the first rack 58 comprises a first line of spaced apertures 62 while the second rack 60 comprises a second line of spaced apertures 64. As best illustrated in FIG. 3a, teeth 66 on the first pinion 54 are adapted for engagement in the apertures 62 forming the first rack 58. The teeth 68 on the second pinion 56 are similarly adapted to engage in the apertures 64 forming the second rack 60. When the drive motor 50 is activated to rotate the drive shaft 52 and the first and second pinions 54, 56 in a first direction, the flexible door 38 is driven along the guideway 28 to close the first air discharge outlet 34. In contrast, when the drive motor 50 drives the drive shaft 52 and the first and second pinions 54, 56 in the opposite direction, the flexible door 38 is displaced along the guideway 28 in a second direction to open the first air discharge outlet 34. Toward this end it should be appreciated that the barrier section 40 of the flexible door 38 is continuous and rackless so as to prevent any passage of air through the first air discharge outlet 34 when the flexible door is in the closed position.

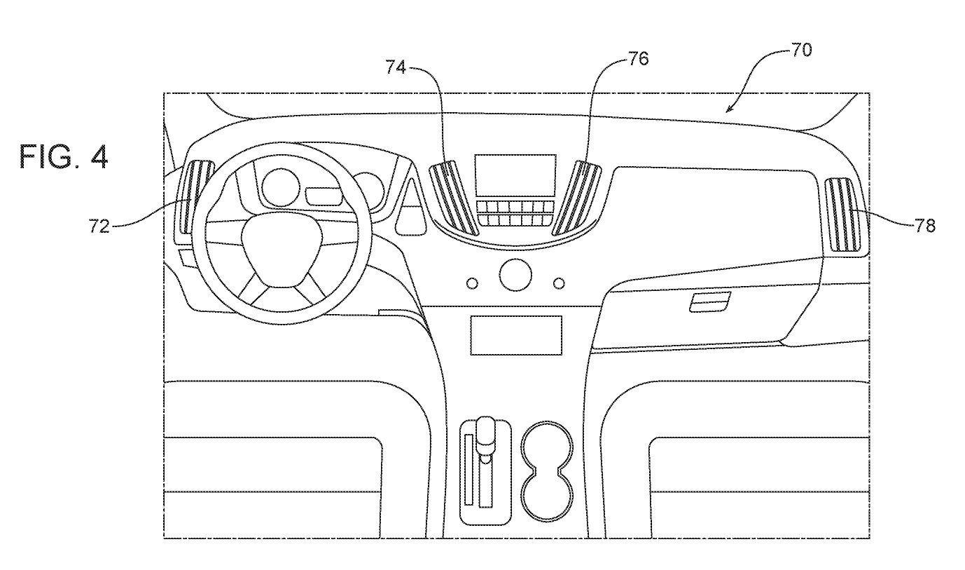

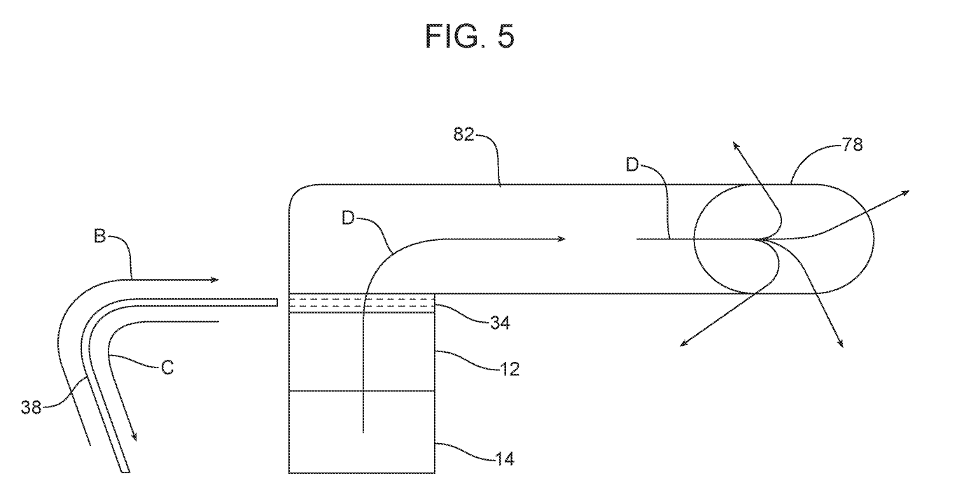

FIG. 4 illustrates the instrument panel 70 of a motor vehicle that may be equipped with the climate control system 10. Conditioned air from the HVAC system may be delivered through the HVAC plenum 14 to various vent registers located throughout the vehicle including, for example, the driver's side outboard vent register 72, the driver's side inboard vent register 74, the passenger side inboard vent register 76 and the passenger side outboard vent register 78. Conditioned air passing through the discharge outlet 80 (see FIG. 1) may be directed to the driver's side outboard vent register 72 and driver's side inboard vent register 74. The conditioned air passing through the second air discharge outlet 36 may be delivered to the passenger side inboard vent register 76. The conditioned air passing through the first air discharge outlet 34 may be delivered to the downstream passenger side outboard vent register 78. Thus, in the illustrated embodiment, it should be appreciated that the outlet shutoff mechanism 12 and more particularly, the flexible door 38 of that outlet shutoff mechanism is adapted to control the flow of conditioned air to the downstream passenger side outboard vent register 78. Accordingly, in the illustrated embodiment when the flexible door 38 is displaced in the direction of action arrow B into the closed position sealing off the first air discharge outlet 34 (note phantom line position in FIG. 5), conditioned air is only being directed into the passenger cabin through the driver's side outboard vent register 72, the driver's side inboard vent register 74 and passenger side inboard vent register 76, thereby effectively providing the climate control system with a driver only mode of operation. In contrast, when the flexible door 38 is displaced in the direction of action arrow C into the open position, conditioned air may again be delivered (note action arrows D) through the first air discharge outlet 34 to the downstream passenger side outboard vent outlet 78 through the duct 82.

While not illustrated, the outlet shutoff mechanism 12 may be utilized to control the flow of conditioned air through any of the vent registers 72, 74, 76, 78 that may be provided downstream from the first air discharge outlet 34 through which airflow may be cut off by closing off the flexible door 38. Thus, for example, in a possible alternative embodiment both the passenger side inboard vent register 76 and the passenger side outboard vent register 78 may be provided downstream of the first air discharge outlet 34 and controlled by the flexible door 38.

As noted above, the guideway 28 of the outlet shutoff mechanism 12 of the illustrated embodiment includes a curve along an intermediate section thereof that defines an acute included angle A. Since the flexible door 38 slides along this guideway 28, it should be appreciated that the flexible door is partially folded back upon itself by the guideway when the flexible door is displaced from the open position to the closed position. Advantageously, this minimizes space requirements for the outlet shutoff mechanism 12 of the climate control system 10 thereby allowing the outlet shutoff mechanism to be utilized in climate control system applications wherein significant package restraints exist within the instrument panel 70 of the motor vehicle. Of course, it should be appreciated that the curvature of the guideway 28 may define a different angle including for example, an obtuse angle where a particular application and existing package constraints require such design.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus, comprising:
a housing, including a guideway and a first air discharge outlet;
a flexible door having an elongated body with a barrier section at a first end and a drive section at a second end, said flexible door being displaceable along said guideway between a first position wherein said first air discharge outlet is open and a second position wherein said first air discharge outlet is closed; and
an actuator feature to displace said flexible door.

2. The apparatus of claim 1, wherein said actuator feature includes a drive motor connected to a drive shaft, a first pinion carried on said drive shaft, and a first rack on said drive section engaged by said first pinion.

3. The apparatus of claim 2, wherein said first rack comprises a first line of apertures provided in said drive section.

4. The apparatus of claim 3, wherein said guideway includes a curve along an intermediate section of said guideway.

5. The apparatus of claim 4, wherein said curve has an arc defining an acute included angle.

6. The apparatus of claim 5, wherein said guideway includes a first guide track and a second guide track opposed to said first guide track.

7. The apparatus of claim 6, wherein said housing includes a first sidewall and a second sidewall, said first guide track carried on said first sidewall and said second guide track carried on said second sidewall.

8. The apparatus of claim 7, wherein said flexible door has a first margin received in said first guide track and a second margin received in said second guide track.

9. The apparatus of claim 8, wherein said actuator feature includes a second pinion carried on said drive shaft and a second rack on said drive section engaged by said second pinion.

10. The apparatus of claim 9, wherein said second rack comprises a second line of apertures provided in said drive section.

11. The apparatus of claim 10, wherein said housing includes a bottom wall extending between said first sidewall and said second sidewall.

12. The apparatus of claim 11, wherein said housing includes a second air discharge outlet.

13. The apparatus of claim 12, wherein said barrier section is continuous and rackless.

14. The apparatus of claim 13, further including an outboard front passenger side air register downstream from said first air discharge outlet.

15. A climate control system, comprising:
an outlet shutoff mechanism; and
an HVAC plenum delivering conditioned air to said outlet shutoff mechanism;
said climate control system being characterized by said outlet shutoff mechanism including (a) a first air discharge outlet connected to a downstream outboard front passenger side air register and (b) a flexible door displaceable along a guideway between a first position wherein said first air discharge outlet is open and a second position wherein said first air discharge outlet is closed and a greater volume of conditioned air is directed toward a driver of a motor vehicle.

16. The climate control system of claim 15, wherein said flexible door has an elongated body including a barrier section at a first end and a drive section at a second end and wherein said outlet shutoff mechanism further includes an actuator feature to displace said flexible door between said first position and said second position.

17. The climate control system of claim 16, wherein said guideway includes a curve along an intermediate section of said guideway having an arc defining an acute included angle.

18. The climate control system of claim 17, wherein said actuator feature includes a drive motor connected to a drive shaft, at least one pinion carried on said drive shaft and at least one rack on said flexible door.

19. The climate control system of claim 18, wherein said at least one rack comprises at least one line of apertures in said flexible door engaged by teeth of said at least one pinion.

20. An apparatus, comprising:
a housing including a guideway and a first air discharge outlet, said guideway including a curve having an arc defining an acute included angle; and
a flexible door displaceable along said guideway between a first position opening said first air discharge outlet and a second position closing said first air discharge outlet.
